(19) United States
(12) Patent Application Publication
(10) Pub. No.: US 2005/0035248 A1
(43) Pub. Date: Feb. 17, 2005

(54) Bolt-on adjustable seat mounting bracket kit

(76) Inventor: Rudolph A. Cuadra JR., Granada Hills, CA (US)

Correspondence Address: Rudolph A. Cuadra, Jr., 11114 Amestoy Avenue, Granada Hills, CA, 91344, US

(21) Appl. No.: 10/422,601

(22) Filed: Aug. 16, 2003

(51) Int. Cl. F16M 11/00

(52) U.S. Cl. 248/201; 248/300

(57) ABSTRACT

A simple bolt-on adjustable seat-mounting bracket designed to provide multiple seat placement options for either the driver or the front passenger side, attaching to the factory seat-mounting studs. The installer or end user has the option of selecting the desired rearward placement of the seat on the seat-mounting adapter prior to installation. The options can be changed at anytime by increasing or decreasing height, rearward placement option or by reversing the installation procedure. This also applies to the optional height adjustment spacer. Once the bracket is installed, the seat bolts onto the seat-mounting bracket. If the optional spacer were used, then it would go between the seat-mounting bracket and the seat. Once the seat is bolted into place, the only function of the seat-mounting bracket is to hold the seat in place. All the other functional seat adjustments such as forward, back and tilt that are built into the seat remain the same and are not affected.

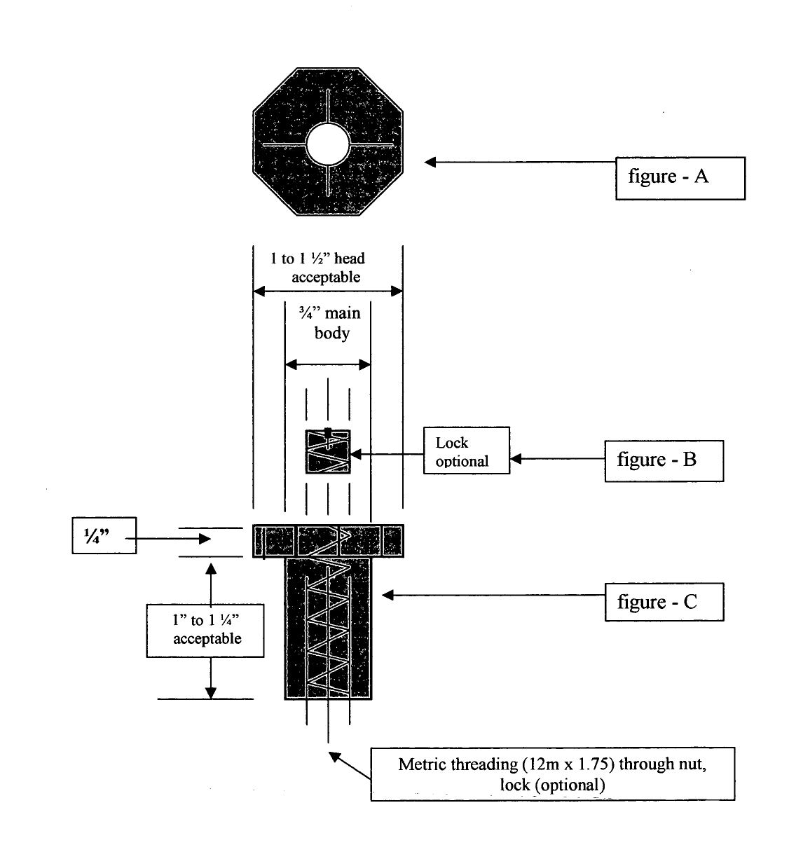

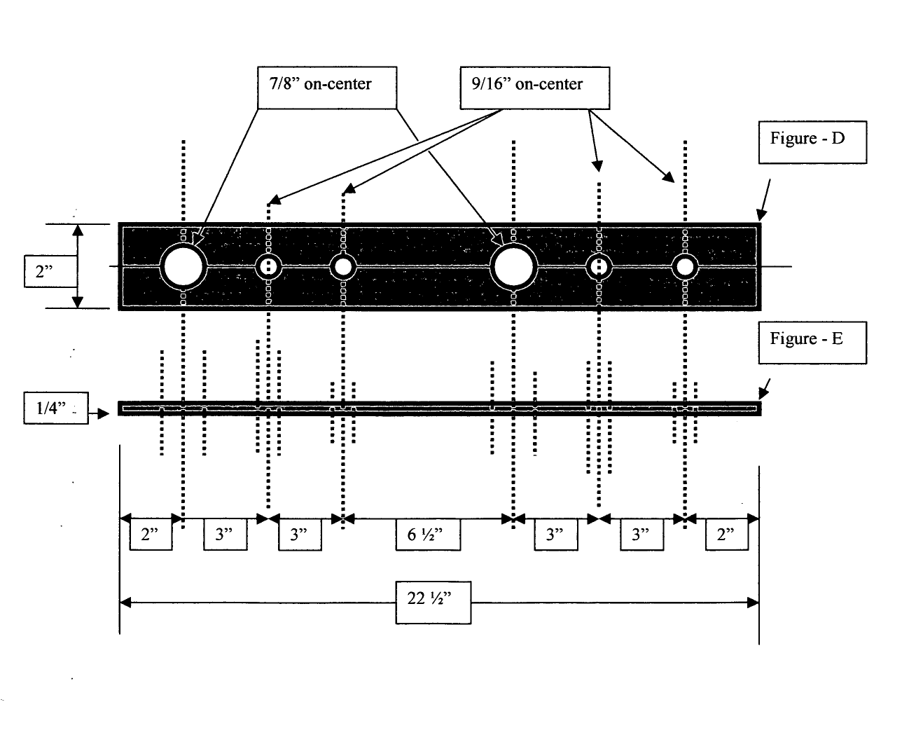

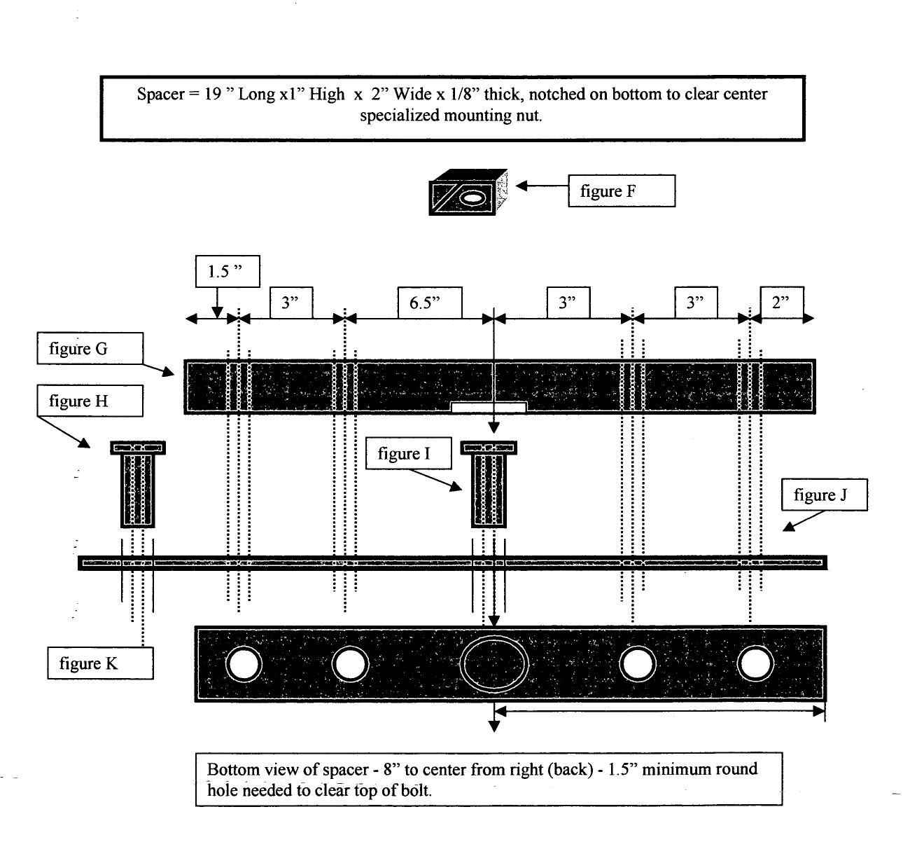

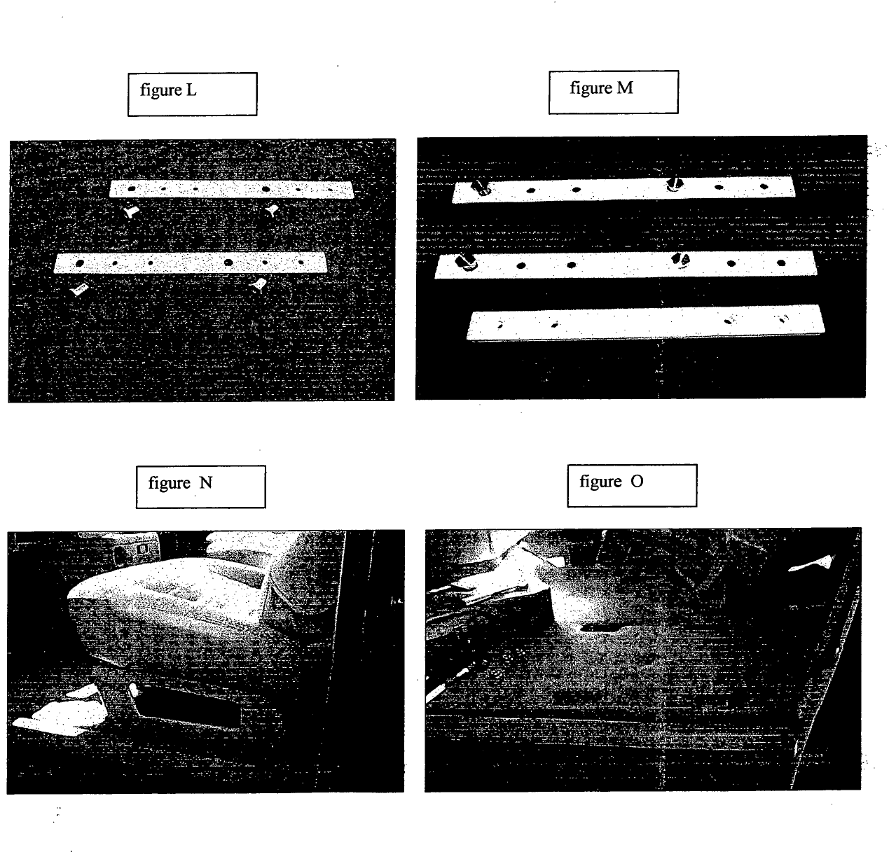

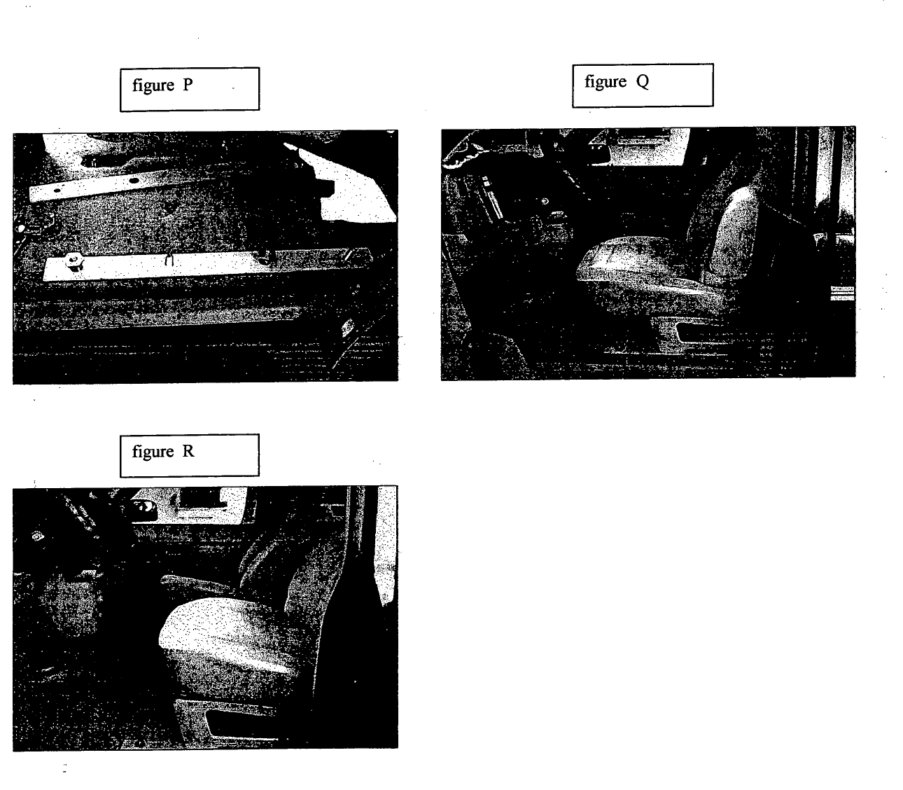

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the Chevrolet Astro and the GMC Safari minivan's limited driver seat and front passenger seat ergonomics, specifically targeting legroom.

2. Background of the Invention

This invention addresses the Chevrolet Astro and the GMC Safari minivan limited driver seat and front passenger seat ergonomics, specifically legroom. The Chevrolet Astro and the GMC Safari minivans are very popular because of their compact exterior size, interior seating, storage capacity, rear drive and able to tow 5,000 pounds plus. However, it has a great disadvantage—that being the limited seat adjustment (front to back) for the driver and front side passenger. This does not apply to all drivers and front seat passengers. This applies mostly for people with longer legs and overweight people needing clearance behind the wheel.

The Chevrolet Astro and the GMC Safari minivan's engine housing protrudes into the passenger compartment between the driver and front passenger and the wheel-wells protrude into the compartment on the left of the driver and right of the passenger. As for the front passenger, this may not be much of a problem because they have a place to rest their feet. However, for the driver it is very restrictive because of the brake and gas pedal placements between the engine housing and wheel-wells. This is especially obvious if one has long legs or is overweight. The driver can rest both his or her feet flat on the floor or prop their left foot on the wheel-well. This becomes very uncomfortable after a long period of time, especially if one has long legs placed in an acute angle.

### BRIEF SUMMARY OF THE INVENTION

This simple aftermarket bolt-on kit application, designed specifically for the early and late model Chevrolet Astro and the GMC Safari minivan only, addresses this issue as stated in the aforementioned Background Of The Invention. It serves as an adapter to increase the rearward placement of the seat by bolting the seat onto the bolt-on adjustable seat mounting bracket kit, which is bolted directly onto the recessed factory threaded seat mounting stud bolts on the minivan's interior floorboard. Thus, dramatically increasing legroom and adding height because it bolts on at floor level as opposed to the seat's recessed factory mounts. This height increase also adds diagonal legroom space that adds comfort, thus reducing stress. The height increase also helps with visibility over the hood, sides, rearview, and helps in gauging distance in traffic and parking.

### BRIEF DESCRIPTION OF DRAWINGS AND PICTURES

Drawings—Page 7—Part #SSN004—Shows special nut configuration and dimensions for this application.

Drawings—Page 8—Part #MAP02—Bolt-on Mounting Bracket configuration.

Drawings—Page 9—Part ##AKS1—Height Adjustment Spacer configuration.

Pictures—Pages 10 & 11—Shows the standard seat-mounting kit, the seat in its original location, seat removed and seat installed on seat mounting bracket kit

### DETAILED DESCRIPTION OF THE INVENTION

Kit Components

Standard Kit Comes with:

1.) 4 ea. washers, standard off the shelf items
2.) 4 ea. specialized nuts, see Drawings Page 7, FIGS. A, B, C, part #SSN004
3.) 2 ea. mounting brackets, see Drawings, Page 8, FIGS. D and E, part #MAP02
4.) 4 ea. 1.5″ long×½″ course thread high strength bolts, standard off the shelf items
5.) 4 ea. 1/2″ nut fasteners, standard off the shelf items
6.) 4 ea. ½″ washers, standard off the shelf items
   Optional Spacer Accessory Kit Comes with:
1.) 2 ea. rectangular tube spacer 2″ wide×2.5″ high×1/8″ thick walls (see Drawings Page 9, FIGS. F, G, and J, part #AKS1), or special order 2 ea. rectangular tube spacer 2″ wide×2″ high×⅛″ thick walls, not pictured or drawn, part #ASK2.
2.) 2 ea. rectangular tube spacer end caps, standard off the shelf items
3.) 4 ea. 2.5″ long×½″ course thread high strength bolts, standard off the shelf items
4.) 4 ea. ½″ nut fasteners, standard off the shelf items.
5.) 4 ea. ½″ washers, standard off the shelf items
   Both the mounting plate and spacer comes in plain primer coated gray or can be ordered in with gray or black powder coating. It can also be special ordered in any powder coated color.

### DESCRIPTION OF THE DRAWINGS AND PICTURES

Drawings—Page 7—Part #SSN004—Shows special nut configuration and dimensions for this application. This nut is made of steel and is used to secure the mounting bracket to the recessed factory seat mounting threaded studs on the interior floorboard.

FIG. A shows top view of nut

FIG. B shows optional lock-nut

FIG. C shows specialized nut

Drawings—Page 8—Bolt-on Mounting Bracket configuration—Part #MAP02.

FIG. D shows a top view of the mounting bracket, configuration and dimensions for this application. The bracket is made of mild steel. The two larger holes, ⅞″, seen on the drawing are where the two specialized nuts go through to secure the bracket to the original recessed factory threaded seat-mounting studs located on the interior floorboard. The first large ⅞″ hole on the left faces the front of the vehicle. The smaller 9/16″ holes that follow are where the ½″ bolts go through from the bottom, threads up, to mount the seat. The first 9/16″ hole from left right places the seat back 3″ from its original position. The second 9/16″ hole from left to right places the seat back 6″ from its original position. Accordingly, if the first 9/16″ hole option on the left is selected, it would line up with the second 9/16″ hole from to left on the opposite end of the bracket because the mounting holes on the seat are exactly 12.5″ apart. On the underside, not drawn, the 9/16″ holes have a Double-D notch to keep the bolts from spinning while being tightened. The same would hold true if the optional height adjustment spacer is used.

FIG. E shows side view of the mounting bracket

Drawings—Page 9—Height Adjustment Spacer configuration (accessory option)—Part #AKS1 shows rectangular tubing used to increase seat height. This is a special order only and is not included in the standard kit. It can be ordered in 1″ or 2″ increments.

FIG. F shows a dimensional view of the hollow tubing with hole centered on the bottom.

FIG. G shows a side view of the hollow tubing's configuration and dimensions. This optional hollow tube spacer goes between the seat-mounting bracket and the seat's mounting frame to add height. The 9/16″ bolt holes on the seat mounting bracket and the tube spacer line up from right (back) to left (front). Note that there is a hole on the bottom that does not go through the tubing. The hole is cut out to clear the top of the second nut, see FIG. D.

FIG. H shows special nut fastener.

FIG. I shows special nut fastener.

FIG. J shows side view of the seat-mounting bracket.

FIG. K shows the bottom side of FIG. G. The hole is cut out to clear the top of the second specialized nut, see FIG. I.

Pictures—Page 10

FIG. L shows the standard seat-mounting kit less the off the shelf nuts and bolts to attach seat.

FIG. M shows the standard seat-mounting bracket kit and one sample spacer, less the off the shelf nuts and bolts. Two spacers are used to complete the optional height adjustment spacer accessory kit.

FIG. N shows the seat in its original location

FIG. O shows seat removed exposing the recessed factory threaded seat mounting stud bolts on the floorboard and the bolt holes on the bottom of the seat frame.

Pictures—Page 11

FIG. P shows one mounting bracket in place with hardware. Please note that this picture of the seat-mounting bracket is the original prototype and not the current version the drawings, descriptions and pictures which has a 3″ and 6″ rearward option. Everything is the same with the exception that the original prototype only had a 6″ placement.

FIG. Q shows the brackets tightened down and seat bolted into place. Please note the base of the driver seat that mounts onto the bracket is set back a full six inches to the maximum provided. The adjustable part of the seat is pushed forward using seat manufacturer adjustments.

FIG. R shows the driver seat pushed back using the seat manufacturer's adjustments to compare it to the passenger side seat pushed back its maximum.

1. A simple aftermarket steel bolt-on adjustable seat mounting bracket kit, that serves as an adapter and is designed specifically for the early and late model Chevrolet Astro and GMC Safari minivans only. It increases the rearward and height placement of the seat by bolting the seat support frame directly onto the bolt-on seat adapter kit which is bolted directly onto the recessed factory threaded seat mounting stud bolts located on the minivan's interior floorboard. A means by which:
(a) the bolt-on kit, and optional spacer accessory, goes between the minivan's original recessed factory seat-mounting threaded stud bolts located on the vehicle's interior floorboard and the seat's metal base support frame which allows the seat to be repositioned further back from the original factory placement to add legroom and height. Once the seat is bolted into place, the only function of the bolt-on kit is to hold the seat in place; and
(b) the adapter kit does not require the altering, defacing, modifying or tampering of any of the original factory parts such as removing obstructions, cutting through carpeting or metal, drilling through carpeting or metal or welding. Everything remains the same except for the four factory nuts that are replaced by the adapter kit. The installation is clean and is completely reversible.
Whereby;
(a) the much needed legroom is increased dramatically by adding the bolt-on adjustable seat mounting kit needed for rearward seat placement in the Chevrolet Astro and the GMC Safari minivans as noted in Consumers Report, www.consumersreport.org, www.edmunds.com and various other popular car magazine publications. When used in conjunction with the manufacturer's own built-in seat adjustments, the driver is offered more flexibility in comfort selections; and
(b) the minimum height increase alone provides added diagonal legroom, better viewing for maneuvering in traffic and parking, thus providing better ergonomics by relieving stress and fatigue that comes from driving in a restrictive environment.
